(19) United States
(12) Patent Application Publication
(10) Pub. No.: US 2014/0149935 A1
(43) Pub. Date: May 29, 2014

(54) User-Intent-Based Chrome

(71) Applicants: Michael Dudley Johnson, San Francisco, CA (US); Keegan Jones, San Francisco, CA (US)

(72) Inventors: Michael Dudley Johnson, San Francisco, CA (US); Keegan Jones, San Francisco, CA (US)

(21) Appl. No.: 13/687,119

(22) Filed: Nov. 28, 2012

(51) Int. Cl. G06F 3/0481

(52) U.S. Cl. CPC G06F 3/0481
USPC 715/811

(57) ABSTRACT

In one embodiment, a method includes monitoring current user interaction with a graphical user interface (GUI) associated with an application on the computing device. The application is associated with one or more of chrome elements for initiating a function of the application. The method also includes predicting future user interaction with the GUI based at least in part on the current user interaction with the GUI. The future user interaction is next with respect to the current user interaction in a sequence of user interactions with the GUI. The method also includes determining a chrome element of the application that is associated with the future user interaction; and providing for display in association with the GUI the chrome element of the application that is associated with the future user interaction.

### TECHNICAL FIELD

This disclosure generally relates to mobile devices.

### BACKGROUND

A mobile computing device—such as a smartphone, tablet computer, or laptop computer—may include functionality for determining its location, direction, or orientation, such as a GPS receiver, compass, or gyroscope. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

In particular embodiments, the chrome or non-content elements of a graphical user interface (GUI) an application executed on a mobile device is modified based on the predicted intent of the user. For example, determination of the user intent may be based on the application detecting a transition between the user consuming content and the user interacting with content displayed by the application. The transition between consuming and interacting with content may be inferred from a change in gestures performed by the user interacting with the application. For example, a bar containing buttons (e.g. status button) may disappear when the user moves from a stationary state to scrolling through content, which may indicate the user is browsing the content and does not intend to do another action. If the user then transitions back to a stationary state by stopping the scrolling, the application may bring the bar and buttons back to the view. The application may infer the user is done reading content and anticipates the user may want to interact with the content (e.g. comment on a status or posted article). As another example, when the user is flipping through photos, the button for comments may disappear. Once the scrolling stops, the comment button may reappear. In particular embodiments, the application or social-networking system may track the accuracy of the chrome modification and improve the determination of the user intent through machine learning.

### BRIEF DESCRIPTION OF THE DRAWINGS

FIG. 1 illustrates an example mobile device.

FIGS. 2A-C illustrate example wireframes for an example GUI.

FIGS. 3A-B illustrate example wireframes for another example GUI.

FIG. 4 illustrates an example method for providing for display of a chrome element that is associated with the future user interaction.

FIG. 5 illustrates an example computing system.

FIG. 6 illustrates an example network environment associated with a social-networking system.

### DESCRIPTION OF EXAMPLE EMBODIMENTS

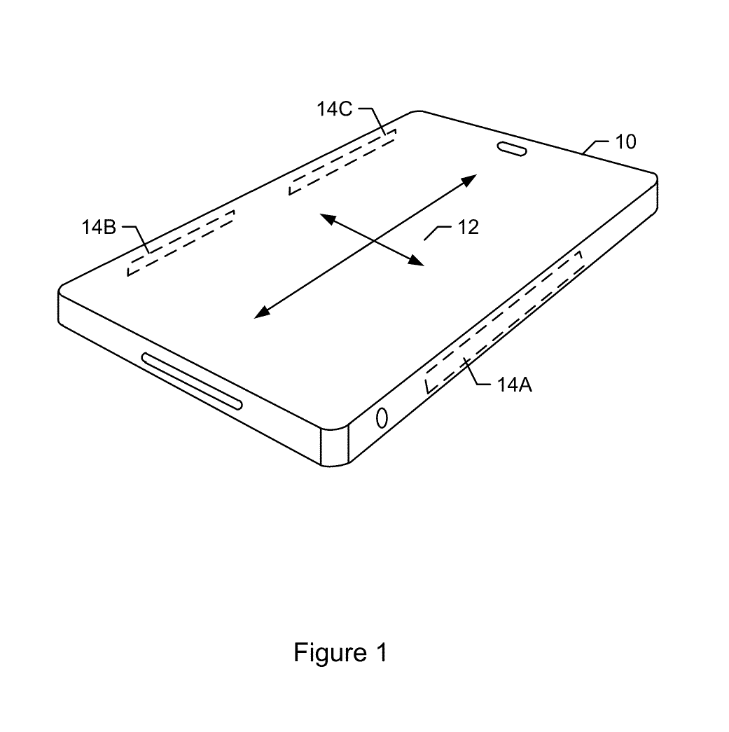

FIG. 1 illustrates an example mobile device. In particular embodiments, the client system may be a mobile device 10 as described above. This disclosure contemplates mobile device 10 taking any suitable physical form. In particular embodiments, mobile device 10 may be a computing system as described below. As example and not by way of limitation, mobile device 10 may be a single-board computer system (SBC) (such as, for example, a computer-on-module (COM) or system-on-module (SOM)), a laptop or notebook computer system, a mobile telephone, a smartphone, a personal digital assistant (PDA), a tablet computer system, or a combination of two or more of these. In particular embodiments, mobile device 10 may have a touch sensor 12 as an input component. In the example of FIG. 1, touch sensor 12 and display may be incorporated on a front surface of mobile device 10. In the case of capacitive touch sensors, there may be two types of electrodes: transmitting and receiving. These electrodes may be connected to a controller designed to drive the transmitting electrodes with electrical pulses and measure the changes in capacitance from the receiving electrodes caused by a touch or proximity input. In the example of FIG. 1, one or more antennae 14A-B may be incorporated into one or more sides of mobile device 10. Antennae 14A-B are components that convert electric current into radio waves, and vice versa. During transmission of signals, a transmitter applies an oscillating radio frequency (RF) electric current to terminals of antenna 14A-B, and antenna 14A-B radiates the energy of the applied the current as electromagnetic (EM) waves. During reception of signals, antennae 14A-B convert the power of an incoming EM wave into a voltage at the terminals of antennae 14A-B. The voltage may be transmitted to a receiver for amplification.

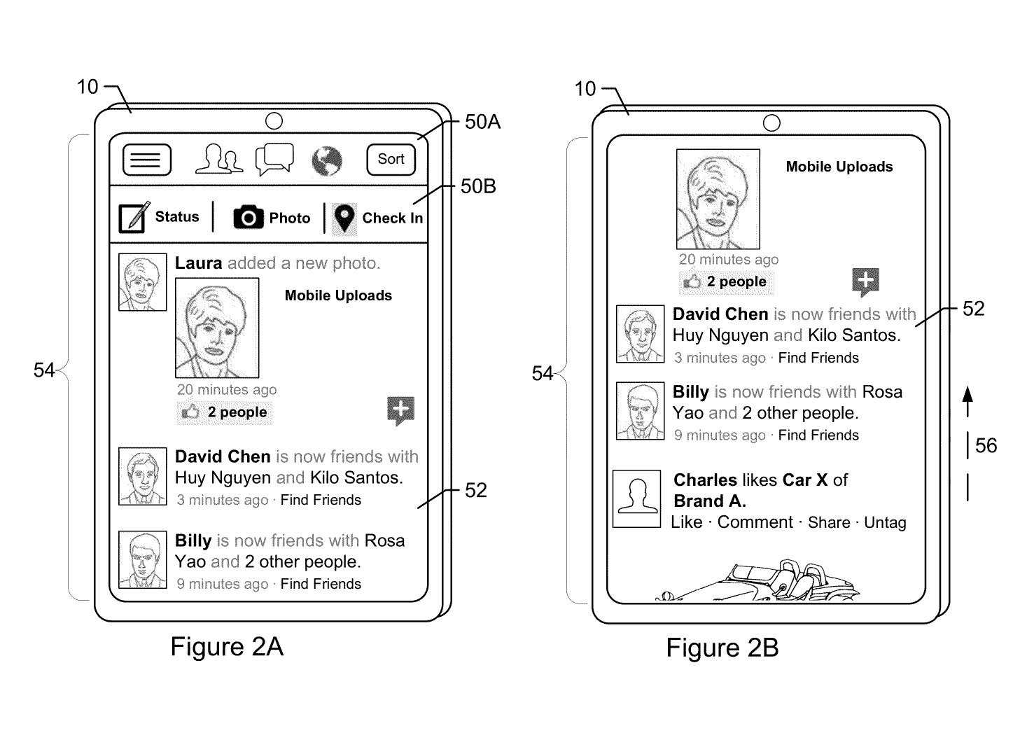

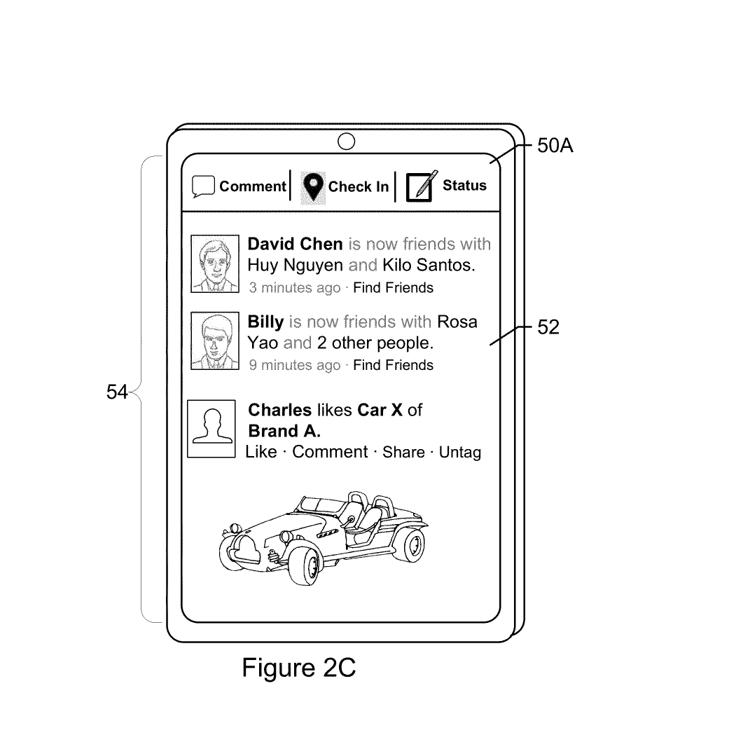

FIGS. 2A-C illustrate example wireframes for user-intent-based chrome. A display 54 integrated on the front surface of mobile device 10 displays a graphical user interface (GUI) associated with an application on mobile device 10. The GUI may include a content region 52 and one or more chrome elements 50A-B. Although this disclosure describes and illustrates particular GUIs each having a particular configuration and number of chrome elements, this disclosure contemplates any suitable GUI having any suitable configuration or number of chrome elements, such as for example, a single chrome element. Moreover, each chrome element may include one or more interactive elements that may provide information about or commands to operate on the displayed objects in content region 52, as opposed to being part of the displayed objects of content region 52. In particular embodiments, an object of content region 52 may correspond to a user-consumable content object. In particular embodiments, an object may be consumed by a user if the user may, for example and without limitation, interact with, view, read, listen to, manipulate, or handle the object. For example, some user-consumable objects may be texts, images, videos, audios, feeds, executables (e.g., application programs or games), websites, webpages, digital books, photo albums, posts, or messages.

In particular embodiments, the GUI may include a first chrome element 50A and a second chrome element 50B, as described below. Moreover, first chrome element 50A and second chrome element 50B, may include one or more elements, such as for example, interactive elements (e.g. icons), content objects (e.g. text), or any combination thereof. In particular embodiments, first 50A or second 50B chrome elements may initiate one or more functions of an application or include a user-consumable object. In particular embodiments, chrome elements 50A-B may be provided by an underlying system such as for example, an operating system, a website, or an application. In the example GUI illustrated in FIG. 2A, first chrome element 50A may display one or more interactive elements for initiating one or more functions of the application, such as for example: a menu (e.g., news feed, events, groups, etc.), friend requests, messages, notifications, and sort (e.g. for sorting the objects of the content region 52 by different criteria). In the example GUI illustrated in FIG. 2A, second chrome element 50B may display one or more interactive elements to access various functions to generate user-consumable objects, such as for example: status (e.g. with text and/or image(s)), check in, and photos (e.g. for uploading from storage or taking a photo). Although this disclosure describes and illustrates particular interactive elements associated with particular functions in particular chrome elements, this disclosure contemplates any suitable chrome element with any suitable combination of interactive elements or content objects, such as for example, a single icon chrome element, a single content object chrome element, or a combination thereof.

In particular embodiments, the display of chrome elements 50A-B associated with the application may be adjusted based at least in part on predicting a future user interaction. As an example and not by way of limitation, adjusting the display of chrome elements 50A-B may include adding or removing one or more interactive elements associated with chrome elements 50A-B based on predicting a future user interaction. The future user interaction may be next with respect to the current user interaction in a sequence of interactions of the user with the GUI. In particular embodiments, predicting the future user interaction may be based at least in part on the current interaction of the user with the GUI. As an example and not by way of limitation, current user interaction may be consuming, generating, or interacting with content objects displayed in the content region 52. In particular embodiments, current user interaction with the GUI may be monitored based in part based on signals corresponding to touch events detected by the touch sensor of mobile device 10. As an example and not by way of limitation, monitored signals for the prediction of future user interaction may include: free scrolling (i.e. flicking and removing the finger from the touch screen), drag scrolling (i.e. scrolling with finger in contact with surface), pinching (i.e. contracting of two fingers), zooming (i.e. spreading of two fingers), tapping, or any sequence of touch events. Although this disclosure describes predicting future user interactions with the GUI through particular signals or touch events, this disclosure contemplates predicting future user interaction with any suitable GUI through any suitable signals or user input.

In the example of FIG. 2B, the user may free scroll 56 through the content objects displayed on display 54. In particular embodiments, free scrolling 56 through the content objects of the content region 52 may provide a signal of the user's future interaction to the application of mobile device 10. As an example and not by way of limitation, the application may determine the user is currently consuming the content objects of content region 52 based at least in part on the signal provided by free scrolling 56. As described above, the application may predict future user interaction with the GUI based at least in part on the current user interaction with the GUI and adjust the display of chrome regions 50A-B based at least in part on predicting the future user interaction. In the example of FIG. 2B, the icons of chrome elements 50A-B are removed in response to predicting further consumption of content objects in content region 52. In particular embodiments, content objects may be displayed in the area of display 54 previously occupied by the one or more interactive elements of chrome elements 50A-B, as illustrated by FIG. 2B.

As described above, the application may adjust the display of chrome elements 50A-B based at least in part on predicting future user interaction with the GUI. In particular embodiments, one or more interactive elements may be added to chrome element 50A in response to predicting the future user interaction is interacting with one or more content objects of content region 52. As an example and not by way of limitation, a drag scroll through the content objects of the content region 52 that ends with a finger in contact with the display 54 may provide a signal of the user's interaction to the application of mobile device 10. The application may predict the future user interaction is to interact with one or more of the content objects of content region 52 based at least in part on the signal provided by the drag scroll. As described above, the application may predict future user interaction with the GUI based at least in part on the current user interaction with the GUI and adjust the display of chrome region 50A based at least in part on predicting the future user interaction. As an example and not by way of limitation, one or more icons of chrome elements 50A may be added in response to predicting the future user interaction is interacting with the content objects of content region 52 or generating a content object. In the example of FIG. 2C, one or more icons of chrome element 50A are added in response to predicting further interaction with the content objects. As an example and not by way of limitation, the application may predict the user may provide a comment related to one or more content objects in response to detecting the drag scroll. Moreover, the application may adjust the display of chrome element 50A to add an interactive element associated with allowing the user to provide a comment regarding one or more displayed content objects. As another example, the application may predict the user may generate one or more content objects and the application may adjust the display of chrome element 50A to add one or icons associated with generating a status update or perform a “check in”. In particular embodiments, the application may remove an interactive element of chrome element 50A-B and replace with one or more interactive elements, such as for example, a “photo” icon may be replaced with a “comment” icon based at least in part on the predicted future user input.

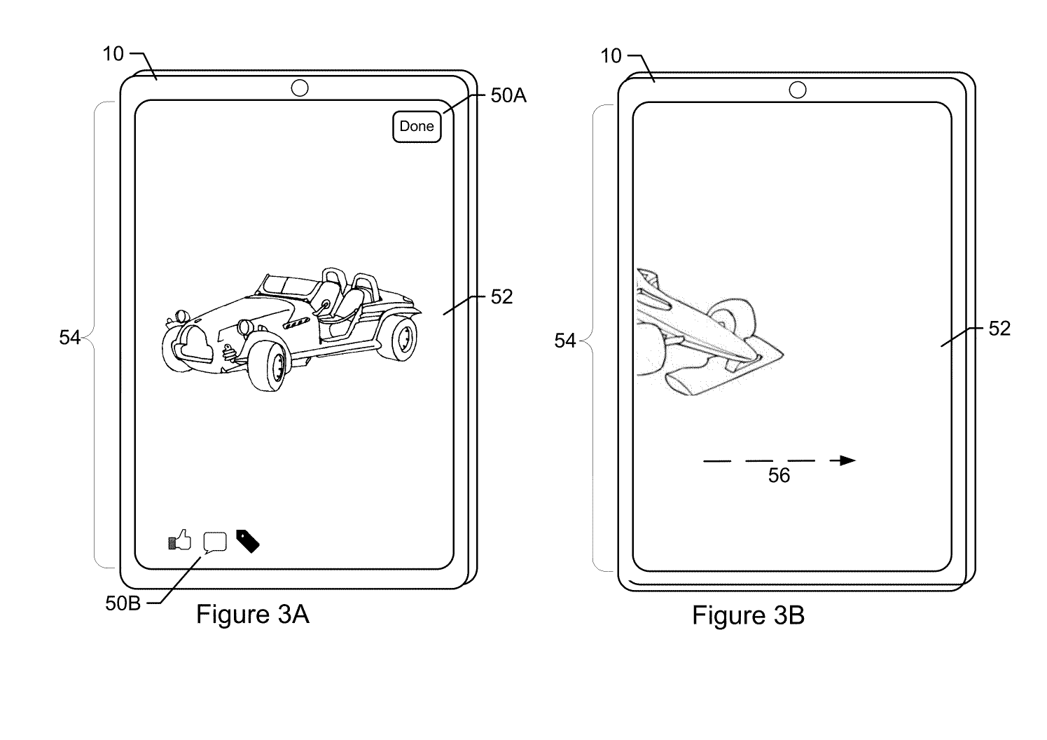

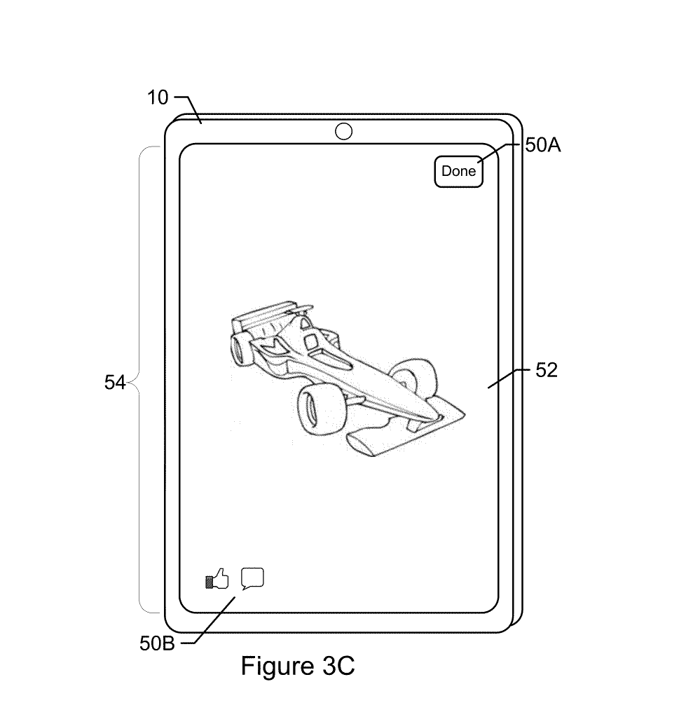

FIGS. 3A-B illustrate example wireframes for user-intent-based chrome of an example photo viewer GUI. In the example of FIG. 3A, content object of content region 52 may correspond to a user-generated photos and the user may consume the content objects through a photo viewer GUI. In particular embodiments, first chrome element 50A may include an interactive element that initiates a function to exit the photo viewer GUI. The second chrome element 50B may include one or more interactive elements that correspond to functionality for interacting with content objects displayed in content region 52, such as for example, providing a comment, “liking”, or “tagging” people in the photos. In the example of FIG. 3B, the user may free scroll 56 through the content objects displayed on display 54. As described above, free scrolling 56 through the content objects of the content region 52 may provide a signal of the user's current interaction to the application of mobile device 10 and the application may determine the future user interaction is additional consumption of the content objects of content region 52. Based on the prediction, the display of chrome elements 50A-B may be adjusted. As illustrated in the example of FIG. 3B, one or more interactive elements of chrome elements 50A-B may be removed in response to the prediction that the future user interaction is to continue consuming the content objects of content region 52.

In particular embodiments, the application may predict future user interaction in response to detecting a particular sequence of touch events, such as for example, a transition from a first signal to a second signal. In particular embodiments, the prediction of the future user interaction may be based on the transition from a first user interaction to a second user interaction that counteracts the first user interaction. As an example and not by way of limitation, the application may predict the future user interaction is interaction with content objects of the application in response to detecting a transition in scrolling from a first direction to a second direction. As another example, the application may predict the future user interaction is interaction with content objects of the application in response to detecting a transition from scrolling to a pause in scrolling. As described above, the application may add one or more interactive elements to chrome region 50A-B based on predicting the future user interaction is interaction with the content objects. In particular embodiments, the application may swap an interactive element of chrome element 50A-B with one or more third-party content objects based at least in part on the predicted future user interaction. As an example and not by way of limitation, a “chat” icon displayed in chrome region 50A-B may be replaced with one or more third-party content objects, such as for example, advertising, in response to the application predicting the future user interaction is consumption of content objects in the content region 52.

As described above, the current user interaction with the GUI associated with the application may be monitored. In particular embodiments, a measure of effectiveness of adding or removing one or more interactive elements of chrome elements 50A-B may be determined based at least in part on monitoring the current user interaction. As an example and not by way of limitation, one or more icons added to chrome elements 50A-B may be determined to be ineffective based on whether the user uses the added icons. As another example, the removal of one or more icons from chrome elements 50A-B may be determined to be ineffective based at least in part on a pause in user interaction with the GUI. In particular embodiments, the application may pop-up help information or new user experience (NUX) in response to a pause in user interaction. In particular embodiments, adjustments to the display of chrome elements 50A-B may be provided based at least in part on the determination of the effectiveness of the adjustments.

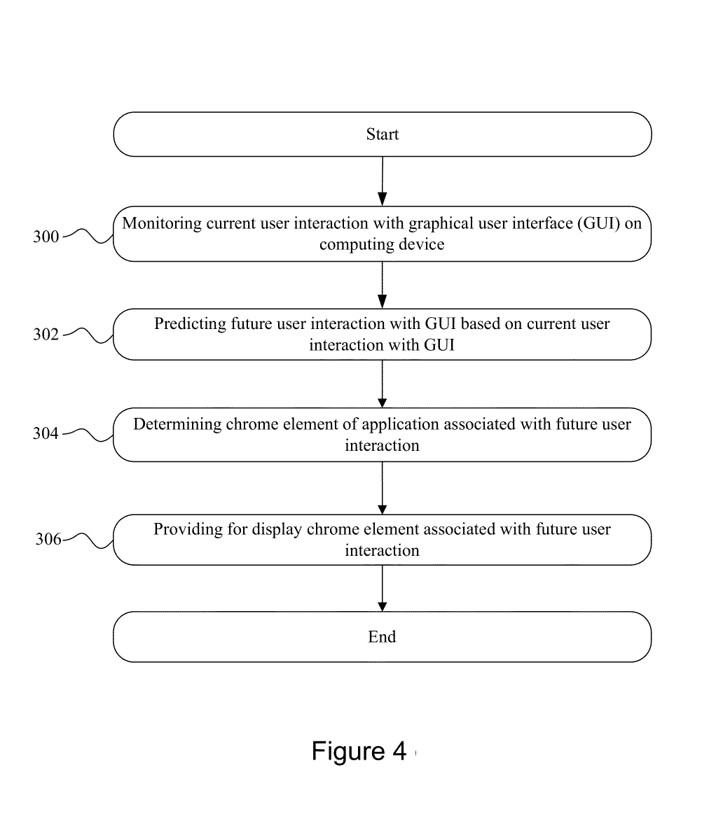

FIG. 4 illustrates an example method for providing for display of a chrome element that is associated with the future user interaction. The method may start at step 300, where a computing device monitors current user interaction with a GUI associated with an application on the computing device. In particular embodiments, one or more of chrome elements that may include one or more interactive elements for initiating one or more functions of the application. Step 302 predicts a future user interaction with the GUI based on the current user interaction with the GUI. In particular embodiments, the future user interaction is the next user interaction with respect to the current user interaction in a sequence of user interactions with the GUI. Step 304 determines a chrome element of the application that is associated with the future user interaction. At step 306, the computing device provides for display in association with the GUI the chrome element of the application that is associated with the future user interaction, at which point the method may end. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates particular components carrying out particular steps of the method of FIG. 4, this disclosure contemplates any suitable combination of any suitable components carrying out any suitable steps of the method of FIG. 4.

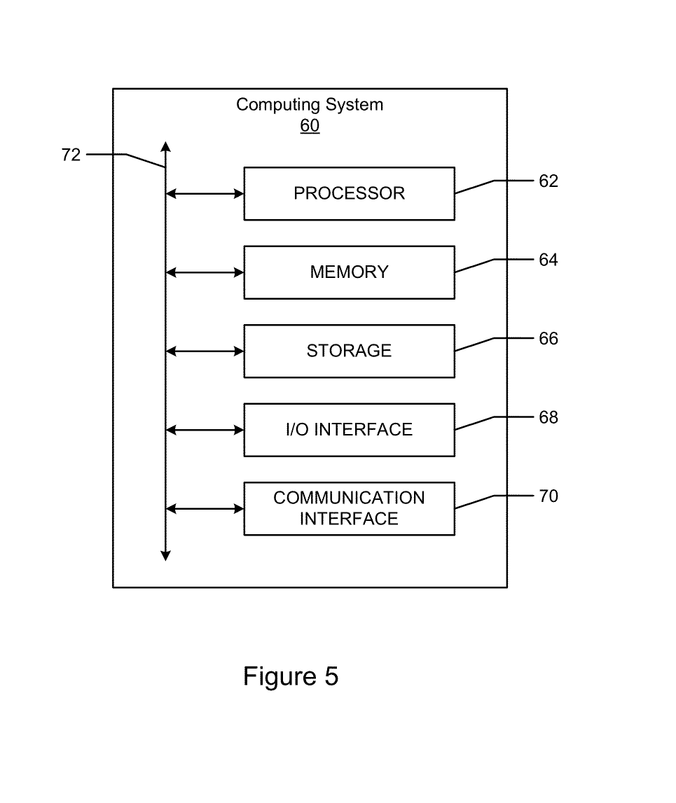

FIG. 5 illustrates example computing system. In particular embodiments, one or more computer systems 60 perform one or more steps of one or more methods described or illustrated herein. In particular embodiments, one or more computer systems 60 provide functionality described or illustrated herein. In particular embodiments, software running on one or more computer systems 60 performs one or more steps of one or more methods described or illustrated herein or provides functionality described or illustrated herein. Particular embodiments include one or more portions of one or more computer systems 60. Herein, reference to a computer system may encompass a computing device, where appropriate. Moreover, reference to a computer system may encompass one or more computer systems, where appropriate.

This disclosure contemplates any suitable number of computer systems 60. This disclosure contemplates computer system 60 taking any suitable physical form. As example and not by way of limitation, computer system 60 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 60 may include one or more computer systems 60; be unitary or distributed; span multiple locations; span multiple machines; span multiple data centers; or reside in a cloud, which may include one or more cloud components in one or more networks. Where appropriate, one or more computer systems 60 may perform without substantial spatial or temporal limitation one or more steps of one or more methods described or illustrated herein. As an example and not by way of limitation, one or more computer systems 60 may perform in real time or in batch mode one or more steps of one or more methods described or illustrated herein. One or more computer systems 60 may perform at different times or at different locations one or more steps of one or more methods described or illustrated herein, where appropriate.

In particular embodiments, computer system 60 includes a processor 62, memory 64, storage 66, an input/output (I/O) interface 68, a communication interface 70, and a bus 72. Although this disclosure describes and illustrates a particular computer system having a particular number of particular components in a particular arrangement, this disclosure contemplates any suitable computer system having any suitable number of any suitable components in any suitable arrangement.

In particular embodiments, processor 62 includes hardware for executing instructions, such as those making up a computer program. As an example and not by way of limitation, to execute instructions, processor 62 may retrieve (or fetch) the instructions from an internal register, an internal cache, memory 64, or storage 66; decode and execute them; and then write one or more results to an internal register, an internal cache, memory 64, or storage 66. In particular embodiments, processor 62 may include one or more internal caches for data, instructions, or addresses. This disclosure contemplates processor 62 including any suitable number of any suitable internal caches, where appropriate. As an example and not by way of limitation, processor 62 may include one or more instruction caches, one or more data caches, and one or more translation lookaside buffers (TLBs). Instructions in the instruction caches may be copies of instructions in memory 64 or storage 66, and the instruction caches may speed up retrieval of those instructions by processor 62. Data in the data caches may be copies of data in memory 64 or storage 66 for instructions executing at processor 62 to operate on; the results of previous instructions executed at processor 62 for access by subsequent instructions executing at processor 62 or for writing to memory 64 or storage 66; or other suitable data. The data caches may speed up read or write operations by processor 62. The TLBs may speed up virtual-address translation for processor 62. In particular embodiments, processor 62 may include one or more internal registers for data, instructions, or addresses. This disclosure contemplates processor 62 including any suitable number of any suitable internal registers, where appropriate. Where appropriate, processor 62 may include one or more arithmetic logic units (ALUs); be a multi-core processor; or include one or more processors 62. Although this disclosure describes and illustrates a particular processor, this disclosure contemplates any suitable processor.

In particular embodiments, memory 64 includes main memory for storing instructions for processor 62 to execute or data for processor 62 to operate on. As an example and not by way of limitation, computer system 60 may load instructions from storage 66 or another source (such as, for example, another computer system 60) to memory 64. Processor 62 may then load the instructions from memory 64 to an internal register or internal cache. To execute the instructions, processor 62 may retrieve the instructions from the internal register or internal cache and decode them. During or after execution of the instructions, processor 62 may write one or more results (which may be intermediate or final results) to the internal register or internal cache. Processor 62 may then write one or more of those results to memory 64. In particular embodiments, processor 62 executes only instructions in one or more internal registers or internal caches or in memory 64 (as opposed to storage 66 or elsewhere) and operates only on data in one or more internal registers or internal caches or in memory 64 (as opposed to storage 66 or elsewhere). One or more memory buses (which may each include an address bus and a data bus) may couple processor 62 to memory 64. Bus 72 may include one or more memory buses, as described below. In particular embodiments, one or more memory management units (MMUs) reside between processor 62 and memory 64 and facilitate accesses to memory 64 requested by processor 62. In particular embodiments, memory 64 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 64 may include one or more memories 64, where appropriate. Although this disclosure describes and illustrates particular memory, this disclosure contemplates any suitable memory.

In particular embodiments, storage 66 includes mass storage for data or instructions. As an example and not by way of limitation, storage 66 may include a hard disk drive (HDD), a floppy disk drive, flash memory, an optical disc, a magneto-optical disc, magnetic tape, or a Universal Serial Bus (USB) drive or a combination of two or more of these. Storage 66 may include removable or non-removable (or fixed) media, where appropriate. Storage 66 may be internal or external to computer system 60, where appropriate. In particular embodiments, storage 66 is non-volatile, solid-state memory. In particular embodiments, storage 66 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 66 taking any suitable physical form. Storage 66 may include one or more storage control units facilitating communication between processor 62 and storage 66, where appropriate. Where appropriate, storage 66 may include one or more storages 66. Although this disclosure describes and illustrates particular storage, this disclosure contemplates any suitable storage.

In particular embodiments, I/O interface 68 includes hardware, software, or both providing one or more interfaces for communication between computer system 60 and one or more I/O devices. Computer system 60 may include one or more of these I/O devices, where appropriate. One or more of these I/O devices may enable communication between a person and computer system 60. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 68 for them. Where appropriate, I/O interface 68 may include one or more device or software drivers enabling processor 62 to drive one or more of these I/O devices. I/O interface 68 may include one or more I/O interfaces 68, where appropriate. Although this disclosure describes and illustrates a particular I/O interface, this disclosure contemplates any suitable I/O interface.

In particular embodiments, communication interface 70 includes hardware, software, or both providing one or more interfaces for communication (such as for example, packet-based communication) between computer system 60 and one or more other computer systems 60 or one or more networks. As an example and not by way of limitation, communication interface 70 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 70 for it. As an example and not by way of limitation, computer system 60 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 60 may communicate with a wireless PAN (WPAN) (such as for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 60 may include any suitable communication interface 70 for any of these networks, where appropriate. Communication interface 70 may include one or more communication interfaces 70, where appropriate. Although this disclosure describes and illustrates a particular communication interface, this disclosure contemplates any suitable communication interface.

In particular embodiments, bus 72 includes hardware, software, or both coupling components of computer system 60 to each other. As an example and not by way of limitation, bus 72 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 72 may include one or more buses 72, where appropriate. Although this disclosure describes and illustrates a particular bus, this disclosure contemplates any suitable bus or interconnect.

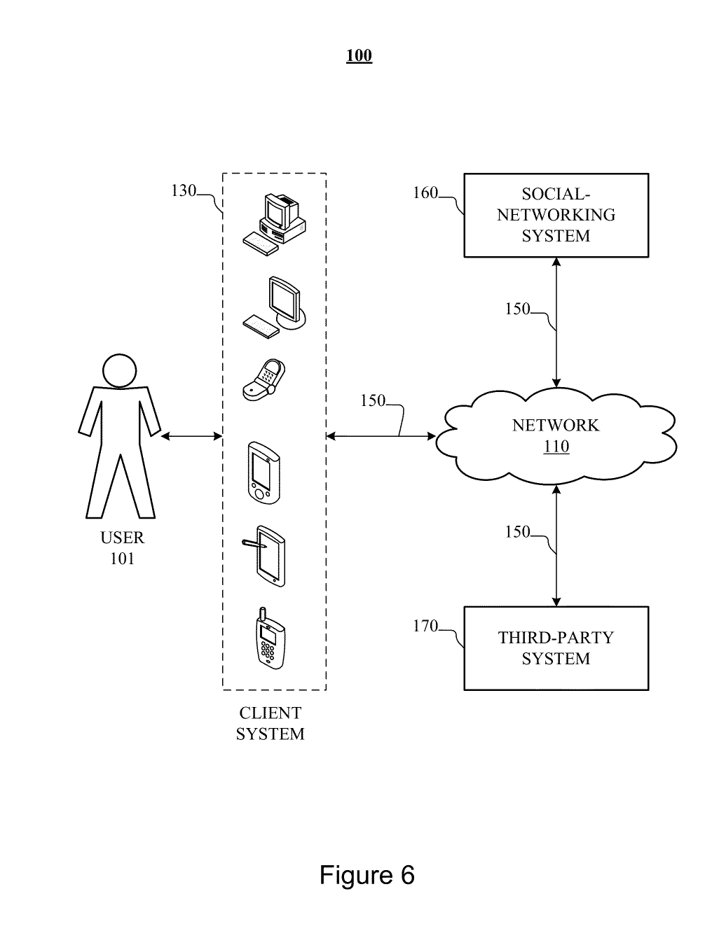

FIG. 6 illustrates an example network environment 100 associated with a social-networking system. Network environment 100 includes a user 101, a client system 130, a social-networking system 160, and a third-party system 170 connected to each other by a network 110. Although FIG. 6 illustrates a particular arrangement of user 101, client system 130, social-networking system 160, third-party system 170, and network 110, this disclosure contemplates any suitable arrangement of user 101, client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 6 illustrates a particular number of users 101, client systems 130, social-networking systems 160, third-party systems 170, and networks 110, this disclosure contemplates any suitable number of users 101, client systems 130, social-networking systems 160, third-party systems 170, and networks 110. As an example and not by way of limitation, network environment 100 may include multiple users 101, client system 130, social-networking systems 160, third-party systems 170, and networks 110.

In particular embodiments, user 101 may be an individual (human user), an entity (e.g. an enterprise, business, or third-party application), or a group (e.g. of individuals or entities) that interacts or communicates with or over social-networking system 160. In particular embodiments, social-networking system 160 may be a network-addressable computing system hosting an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include an authorization server that allows users 101 to opt in or opt out of having their actions logged by social-networking system 160 or shared with other systems (e.g. third-party systems 170), such as, for example, by setting appropriate privacy settings. Third-party system 170 may be accessed by the other components of network environment 100 either directly or via network 110. In particular embodiments, one or more users 101 may use one or more client systems 130 to access, send data to, and receive data from social-networking system 160 or third-party system 170. Client system 130 may access social-networking system 160 or third-party system 170 directly, via network 110, or via a third-party system. As an example and not by way of limitation, client system 130 may access third-party system 170 via social-networking system 160. Client system 130 may be any suitable computing device, such as, for example, a personal computer, a laptop computer, a cellular telephone, a smartphone, or a tablet computer.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a computing device, monitoring current user interaction with a graphical user interface (GUI) associated with an application on the computing device, the application being associated with one or more chrome elements for initiating one or more functions of the application;
by the computing device, predicting future user interaction with the GUI based at least in part on the current user interaction with the GUI, the future user interaction being next with respect to the current user interaction in a sequence of user interactions with the GUI;
by the computing device, determining a chrome element of the application that is associated with the future user interaction; and
by the computing device, providing for display in association with the GUI the chrome element of the application that is associated with the future user interaction.

2. The method of claim 1, wherein providing for display comprises adding one or more interactive elements to or removing one or more interactive elements from the chrome element that is associated with the future user interaction based at least in part on the prediction.

3. The method of claim 1, wherein predicting the future user interaction comprises determining whether the user is currently interacting with, generating, or consuming one or more content objects associated with the application.

4. The method of claim 3, wherein providing for display comprises removing one or more interactive elements from the chrome element that is associated with the future user interaction based at least in part on determining the user is currently consuming the content objects.

5. The method of claim 4, wherein determining the user is currently consuming the content objects comprises detecting a touch gesture corresponding to scrolling through the content objects.

6. The method of claim 3, wherein providing for display comprises adding one or more interactive elements to the chrome element that is associated with the future user interaction based at least in part on predicting the user is currently interacting with the content objects.

7. The method of claim 6, wherein determining the user is currently interacting with the content objects comprises detecting a touch gesture corresponding to a pause of scrolling through the content objects.

8. One or more computer-readable non-transitory storage media embodying logic configured when executed to:
monitor current user interaction with a graphical user interface (GUI) associated with an application on a computing device, the application being associated with one or more chrome elements for initiating one or more functions of the application;
predict future user interaction with the GUI based at least in part on the current user interaction with the GUI, the future user interaction being next with respect to the current user interaction in a sequence of user interactions with the GUI;
determine a chrome element of the application that is associated with the future user interaction; and
provide for display in association with the GUI the chrome element of the application that is associated with the future user interaction.

9. The media of claim 8, wherein the logic is further configured to add one or more interactive elements to or remove one or more interactive elements from the chrome element that is associated with the future user interaction based at least in part on the prediction.

10. The media of claim 8, wherein the logic is further configured to determine whether the user is currently interacting with, generating, or consuming one or more content objects associated with the application.

11. The media of claim 10, wherein the logic is further configured to remove one or more interactive elements from the chrome element that is associated with the future user interaction based at least in part on determining the user is currently consuming the content objects.

12. The media of claim 11, wherein the logic is further configured to detect a touch gesture corresponding to scrolling through the content objects.

13. The media of claim 10, wherein the logic is further configured to add one or more interactive elements to the chrome element that is associated with the future user interaction based at least in part on predicting the user is currently interacting with the content objects.

14. The media of claim 13, wherein the logic is further configured to detect a touch gesture corresponding to a pause of scrolling through the content objects.

15. A device comprising:
a processor;
one or more computer-readable non-transitory storage media coupled to the processor and embodying software that:
monitor current user interaction with a graphical user interface (GUI) associated with an application on the device, the application being associated with one or more of chrome elements for initiating one or more functions of the application;
predict future user interaction with the GUI based at least in part on the current user interaction with the GUI, the future user interaction being next with respect to the current user interaction in a sequence of user interactions with the GUI;
determine a chrome element of the application that is associated with the future user interaction; and
provide for display in association with the GUI the chrome element of the application that is associated with the future user interaction.

16. The device of claim 15, wherein the logic is further configured to add one or more interactive elements to or remove one or more interactive elements from the chrome element that is associated with the future user interaction based at least in part on the prediction.

17. The device of claim 15, wherein the logic is further configured to determine whether the user is currently interacting with, generating, or consuming one or more content objects associated with the application.

18. The device of claim 17, wherein the logic is further configured to remove one or more interactive elements from the chrome element that is associated with the future user interaction based at least in part on determining the user is currently consuming the content objects.

19. The device of claim 18, wherein the logic is further configured to detect a touch gesture corresponding to scrolling through the content objects.

20. The device of claim 17, wherein the logic is further configured to add one or more interactive elements to or remove one or more interactive elements from the chrome element that is associated with the future user interaction based at least in part on predicting the user is currently interacting with the content objects.
